(19) United States
(12) Patent Application Publication
(10) Pub. No.: US 2009/0217199 A1
(43) Pub. Date: Aug. 27, 2009

(54) Information Retrieving and Displaying Method and Computer-Readable Medium

(76) Inventors: Yoshihaki Hara, Tokyo (JP); Kentaro Kai, Redmond, WA (US); Yasuhiko Mori, Choufu (JP); Sachihiko Ogushi, Tokyo (JP); Hirokazu Sawada, Tokyo (JP); Yoshito Yamane, Tokyo (JP)

Correspondence Address: MERCHANT & GOULD (MICROSOFT), P.O. BOX 2903, MINNEAPOLIS, MN, 55402-0903, US

(21) Appl. No.: 11/917,667

(22) PCT Filed: Jun. 29, 2006
(86) PCT No.: PCT/US2006/025412

§ 371 Date: Oct. 21, 2008

(30) Foreign Application Priority Data
Jun. 30, 2005 (JP) 2005-192932

(51) Int. Cl. G06F 17/30; G06F 3/048

(52) U.S. Cl. 715/808; 707/3; 707/E17.016; 709/206

(57) ABSTRACT

There is provided a technique for extracting from information stored in a computer system, all information associated with a certain keyword and displaying it in a manner for easy recognition by a user. An information retrieving and displaying method for extracting from information stored in a computer system, all information associated with a certain keyword and displaying it in a classified and highlighted manner for easy recognition by a user, comprises steps of: retrieving information including a keyword specified by the user as the certain keyword; extracting information about contact addresses included in the information retrieved by the retrieving step; and displaying in a list the information about the contact addresses extracted by the extracting step.

### BACKGROUND OF THE INVENTION

1. Field of the Invention

The present invention relates to an information retrieving and displaying method and a computer-readable medium having a program stored thereon for causing a computer to execute the information retrieving and displaying method.

2. Description of the Related Art

Various types of information are stored in computer systems. For example, instead of handing a paper business card to a person, an e-mail on the Internet may be used to inform the person on personal information (hereafter referred to as business card information), such as the name, corporate name, phone number, and e-mail address, listed on the business card. As disclosed in Japanese Patent Laid-Open No. 2000-32033,a service is also known that allows users to register the business card information in a server computer so that client computers of registered users exchange the registered business cards with each other via the server. Thus, various types of information may be stored in computer systems, including information communicated from one person to another like the business card information.

Typically, information desired by a user is retrieved from information stored in a computer system by the user specifying a definite search keyword. Then, only information that matches the search keyword is extracted and displayed as the search result.

However, situations may often occur in which the user cannot specify a definite search keyword due to an uncertain memory even though the user has an object to search for. For example, if the user has forgotten the name of a person to contact, it is difficult to find the contact address in an address book. In such cases, a method to find the contact address based on some other reliable information is required. Conventional information retrieving methods only retrieve information that matches a search keyword, and they cannot obtain desired information (i.e., information on the target contact address) in such cases as above. On the other hand, if related information is retrieved in addition to the information that exactly matches a search keyword, more information may be included than in the conventional retrieving methods. Therefore, the information needs to be displayed in a manner that facilitates user recognition.

A user sends and receives information, such as documents and the business card information, to and from people by e-mails or other means. However, in the flood of information, it is difficult to remember, for example, which documents have been sent to and received from a particular contact address. With this being the situation, there has been a need to comprehensively know documents sent and received between the user and contact addresses related to the user.

The present invention has been made in the light of the above issues, and an object of the present invention is to provide an information retrieving and displaying method for extracting from information stored in a computer system, all information associated with a certain keyword and displaying it in a manner that facilitates user recognition, and to provide a computer-readable medium having a program for the method stored thereon.

### SUMMARY OF THE INVENTION

To achieve the above object, an information retrieving and displaying method according to the present invention is an information retrieving and displaying method for extracting from information stored in a computer system, all information associated with a certain keyword and displaying it in a classified and highlighted manner for easy recognition by a user, the method comprising steps of: retrieving information including a keyword specified by the user as the certain keyword; extracting information about contact addresses included in the information retrieved by the retrieving step; and displaying in a list the information about the contact addresses extracted by the extracting step.

In this information retrieving and displaying method, the displayed list may include a contact address list, and when a name of a contact address in the displayed contact address list is indicated by a predetermined indicating means, information indicating why the extracted information is found may be displayed in a pop-up manner.

In this information retrieving and displaying method, the indication by the indicating means may be indication by an input device such as a mouse.

In this information retrieving and displaying method, the computer system may be a network system, and the information stored in the computer system may be information stored in a server and a terminal which constitute the network system.

An information retrieving and displaying method according to the present invention is an information retrieving and displaying method for extracting from information stored in a computer system, all information associated with a certain keyword and displaying it in a classified and highlighted manner for easy recognition by a user, the method comprising steps of: retrieving electronic documents which the user has sent or received using information about contact addresses related to the user as the certain keyword; and displaying in a list the information about the electronic documents retrieved by the retrieving step.

In this information retrieving and displaying method, the information about the contact addresses related to the user may include at least information about contact addresses registered by the user.

In this information retrieving and displaying method, the information about the contact addresses related to the user may include various contact addresses specified in electronic mail or the like, such as “From”, “To”, and “CC.”

In this information retrieving and displaying method, the information about the electronic documents corresponding to one of the contact addresses related to the user may be displayed in a list.

In this information retrieving and displaying method, the list may further include a contact address list having names of the contact addresses related to the user, and may display in a list the information about the electronic documents corresponding to one of the contact addresses in the contact address list.

In this information retrieving and displaying method, the computer system may be a network system, and the information stored in the computer system may be information stored in a server and a terminal which constitute the network system.

A computer-readable medium according to the present invention is a computer-readable medium having a program stored thereon, the program causing a computer to execute an information retrieving and displaying method for extracting from information stored in a computer system, all information associated with a certain keyword and displaying it in a classified and highlighted manner for easy recognition by a user, the program comprising the steps of: retrieving information including a keyword specified by the user as the certain keyword; extracting information about contact addresses included in the information retrieved by the retrieving step; and displaying in a list the information about the contact addresses extracted by the extracting step.

In this computer-readable medium, the displayed list may include a contact address list, and when a name of a contact address in the displayed contact address list is indicated by a certain indicating means, information indicating why the extracted information is found may be displayed in a pop-up manner.

In this computer-readable medium, the indication by the indicating means may be indication by an input device such as a mouse.

In this computer-readable medium, the computer system may be a network system, and the information stored in the computer system may be information stored in a server and a terminal which constitute the network system.

A computer-readable medium according to the present invention is a computer-readable medium having a program stored thereon, the program causing a computer to execute an information retrieving and displaying method for extracting from information stored in a computer system, all information associated with a certain keyword and displaying it in a classified and highlighted manner for easy recognition by a user, the program comprising the steps of: retrieving electronic documents which the user has sent or received using information about contact addresses related to the user as the certain keyword; and displaying in a list the information about the electronic documents retrieved by the retrieving step.

In this computer-readable medium, the information about the contact addresses related to the user may include at least information about contact addresses registered by the user.

In this computer-readable medium, the information about the contact addresses related to the user may include various contact addresses specified in electronic mail or the like, such as “From”, “To”, and “CC.”

In this computer-readable medium, the information about the electronic documents corresponding to one of the contact addresses related to the user may be displayed in a list.

In this computer-readable medium, the list may further include a contact address list having names of the contact addresses related to the user, and may display in a list the information about the electronic documents corresponding to one of the contact addresses in the contact address list.

In this computer-readable medium, the computer system may be a network system, and the information stored in the computer system may be information stored in a server and a terminal which constitute the network system.

While both the terms e-mail and document are used herein, a document is intended to be any electronic document, including an e-mail document.

According to the present invention, user-desired information, especially personal information and communicated electronic documents, may be comprehensively retrieved even with only an uncertain memory, and the retrieved information may be provided in a display that facilitates user recognition.

The above and other objects, effects, features and advantages of the present invention will become more apparent from the following description of an embodiment thereof taken in conjunction with the accompanying drawings.

### BRIEF DESCRIPTION OF THE DRAWINGS

FIG. 1 is a block diagram showing an overall configuration of a system in an embodiment of the present invention;

FIG. 2 is a flowchart showing a process in an example of information processing according to the present invention;

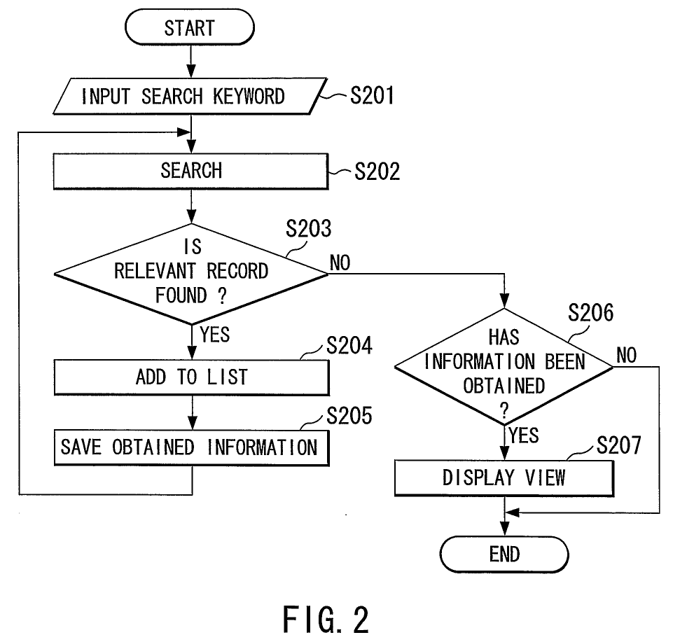

FIG. 3 is a diagram for describing the process of FIG. 2;

FIG. 4 is an exemplary display of a search result according to the example;

FIG. 5 is an exemplary display of a search result according to the example;

FIG. 6 is a flowchart showing a process in another example of the information processing according to the present invention; and

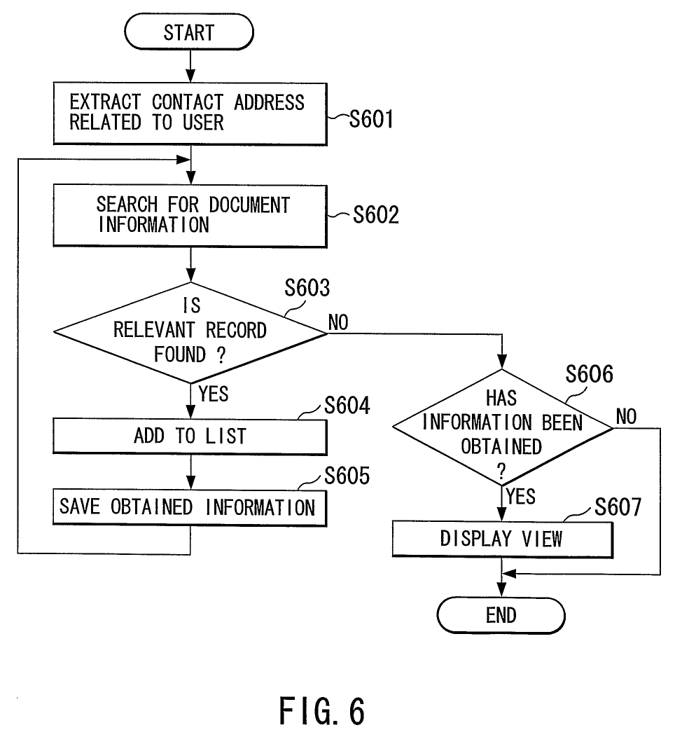

FIG. 7 is an exemplary display of a search result according to the example.

### DETAILED DESCRIPTION OF PREFERRED EMBODIMENT

An embodiment of the present invention will be described in detail below with reference to the appended drawings.

While the present invention may be implemented in a general computer system or network system, the description below will be given specifically for the case where the present invention is applied to an electronic business card exchange system.

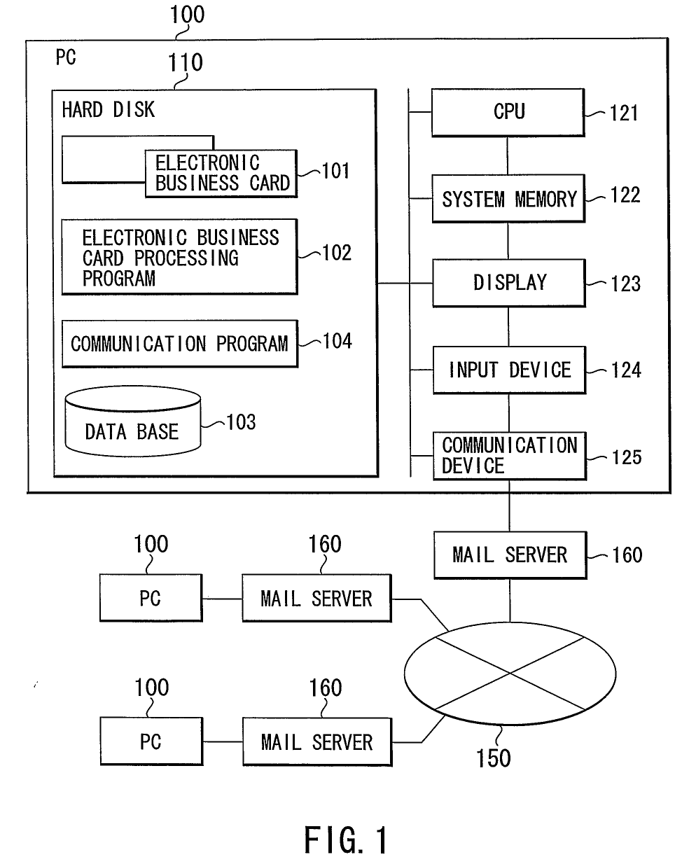

FIG. 1 shows a system configuration of an electronic business card exchange system to which the present invention is applied.

The electronic business card exchange system in this embodiment includes personal computers (hereafter referred to as PCs) 100 connected with each other via a communication network 150.

Since commercially available PCs may be used as the PCs 100, description of the hardware will be given only briefly. A personal computer 100 has a hard disk 110, a CPU 121, a system memory 122, a display 123, an input device 124, and a communication device 125 such as a modem.

The CPU 121 executes various programs, such as an operating system and application programs. The system memory 122 stores instructions executed by the CPU 121 and input/output information for the CPU 121. The display 123 displays results of information processing of the CPU 121 and input information from the input device 124 on a display screen under the control of the CPU 121. The input device 124 has a pointing device (such as a mouse) and a keyboard, and it inputs information to the CPU 121.

The communication device 125 sends and receives e-mails to and from a mail server 160 in a provider via the communication network 150. The communication device 125 also connects to the communication network 150 to communicate with the other PCs 100. The mail server 160 sends and receives e-mails to and from other mail servers 160 via the communication network 150. An example of the communication network 150 may be a wide area network such as the Internet.

The hard disk 110 stores the following objects (programs) according to the present invention. Electronic business cards 101 are objects generated by an electronic business card processing program 102 or received from the other PCs 100, and stored in the hard disk 110. Each electronic business card 101 is a data set (a collection of data items) including a character string in the form of character codes and image data of the background image of the business card.

The electronic business card processing program 102 is a program with an electronic business card generation function and a contact record management function. The electronic business card processing program 102 is installed on the hard disk 110 from a computer-readable storage medium such as a CD-ROM or flexible disk, or via a communication medium. A database 103 stores information for managing the generated and received electronic business cards, and various types of information associated with the electronic business cards (which may include management information).

Computer-readable media may be any available media, including both volatile and nonvolatile media and removable and non-removable media. Computer-readable media may include the above-mentioned computer-readable storage medium and communication medium. Computer-readable storage media include both volatile and nonvolatile media and removable and non-removable media implemented in any method or technology for storage of information such as computer-readable instructions, data structures, program modules, or other data. Computer-readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic devices, or any other medium which can be used to store desired information and which can by accessed by the PC 100. Communication media typically embodies computer readable instructions, data structures, program modules, or other data in a modulated data signal such as a carrier wave or other transport mechanism and includes any information delivery media. The term “modulated signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of the any of the above should also be included within the scope of computer-readable media.

The electronic business card processing program 102 has the following functions.

(1) electronic business card generation function

This function allows generation and edition of the business cards in the form of images.

(2) contact record management

When an electronic card is sent or received, a communication record of the sending or receiving is recorded in the database 103 and managed as a contact record.

These functions have been implemented by application software such as Microsoft Office InterConnect 2004, which is application software provided by the present applicant.

Information stored and managed in the database 103 includes the following information.

(1) the date and time of generation, type, and memory location for each generated electronic business card 101, and additional information such as the security setting for the electronic business card

(2) the contact record about each electronic business card

The contact record includes a communication record containing: the receiving data and time, the sender's e-mail address, and the sender's name for each received electronic business card 101; and the sending date and time, the recipient's e-mail address, and the recipient's name for each sent electronic business card. The contact record further includes various types of contact information entered by the user with the input device 124 such as a keyboard, and various types of contact information about contact made with persons indicated by the electronic business cards.

(3) an address book generated based on personal information obtained from the electronic business cards, and other business card-related information

(4) address books generated by various types of application software

Information on an address book generated based on personal information obtained from the electronic business cards, and other business card-related information, are stored in the database 103 in association with the electronic business cards managed by the apparatus. In this embodiment, address books generated by various types of application software are also stored in the database 103. Even though the address books are generated by various types of application software different from the electronic business card processing program, the address books may be associated with the electronic business cards if they contain information corresponding to the business card information about the electronic business cards. A plurality of types of data listed above may be stored in the database 103 as one record (a data set), or these types of information may be stored in the database 103 on an information type basis.

Information processing according to the present invention will be described below.

It is assumed here that the information processing described below is performed by the electronic business card processing program 102.

### EXAMPLE 1

This example implements a retrieving method that allows retrieving information about a target contact address (not limited to that of a person but including that of a company, place, etc.) even when a definite keyword (such as a person's name) cannot be used for a search, for example when the name of a person to contact has been forgotten.

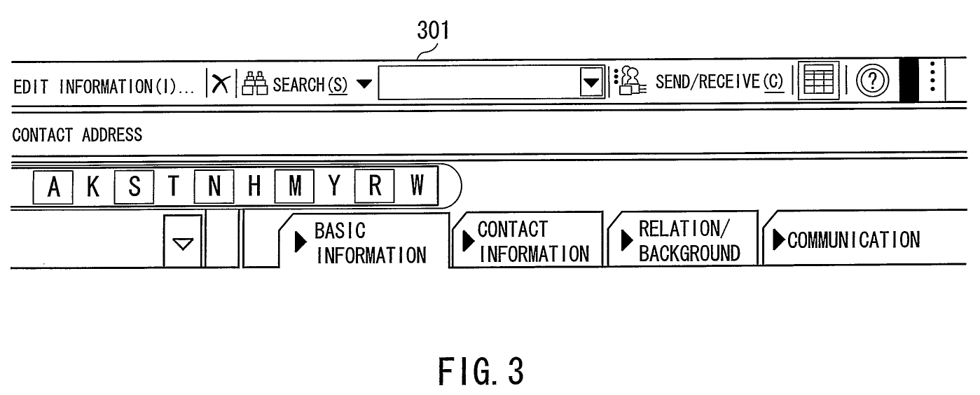

First, an input of a word or a character string associated with a contact address to be searched for is received as a search keyword (for example, if a person's contact address is searched for, the search keyword may be the name of the person's company or section, the title of an event that the person attended, etc.) (step S201). For example, an input box 301 for search shown in FIG. 3 accepts the search keyword.

Then, the database is queried for the input search keyword to obtain contact address-related information in a record corresponding to the search keyword (step S202). For example, if the target is a person, the contact address-related information include certain information such as the person's name, the name of the person's company or section, the person's background, the title of an event that the person attended, and the person's contact address (the phone number, e-mail address, etc.).

When this information is obtained at step S202, the name of the contact address in the obtained contact address-related information is added to a list (step S204). The name of the contact address included in this list is associated with the information obtained at step S202.

Further, the information obtained by the search at step S202 is saved (step S205).

Subsequently, steps S202 to S205 are repeated until no more records relevant to the search keyword are found, at which point the processing transitions to step S206. If the information has been obtained, a view of the list and detailed information about the retrieved contact addresses is displayed (this view including the detailed information may be displayed in such a manner that a portion displayable in the display area is displayed and the remaining portion is displayed by scrolling) (step S207).

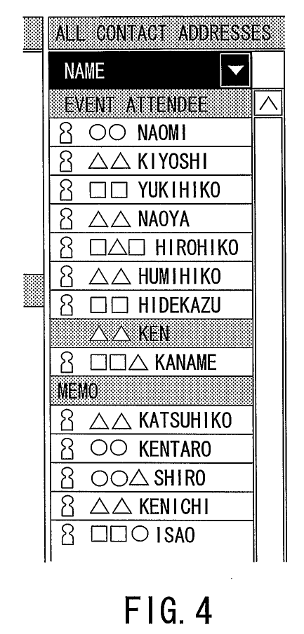

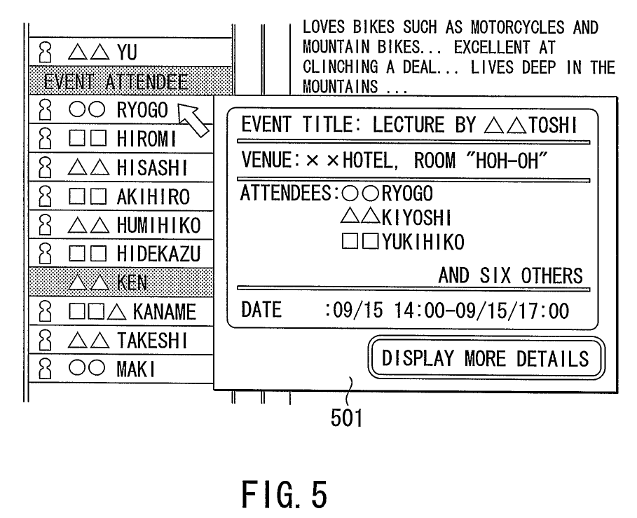

FIGS. 4 and 5 show exemplary displays of a search result.

As shown in FIG. 4, a view or list of the names of the contact addresses is displayed as the search result (in FIG. 4, the names of the contact addresses are displayed in predetermined categories).

When a particular name in the list displayed in this manner is specified using indicating means implemented as an input device such as a mouse, for example when a mouse pointer is placed on the name, detailed information about that particular contact address (specifically, information indicating why the contact address is found) is displayed in a pop-up manner (see FIG. 5: 501).

In the exemplary pop-up display in FIG. 5, the event title, venue, attendees, and date are displayed to indicate that this contact address corresponds to a person who attended the particular event. The detailed information displayed in a pop-up manner like this is not limited to this example. For example, if the contact address is of a person, the name of the person's company or section, the person's position, the person's contact address (the phone number, e-mail address, etc.) may be displayed. If the obtained information includes data on a photograph of the person, the photograph may be displayed at the upper left of the pop-up display (not shown), for example. Further clicking a “Display More Details” button in the pop-up display may cause more detailed information to be displayed.

The information in this pop-up display allows the user to readily know why the contact address is found. Since the contact address list and the detailed information about the contact addresses are simultaneously displayed and each is displayed in a classified and highlighted manner in predetermined categories, recognition by the user is facilitated. Under the pop-up display in this figure (i.e., at the right of the displayed list), there is a view of the obtained information, in which detailed information for the names in the list is displayed as a list (in FIG. 5, this detailed information is hidden under the pop-up display).

### EXAMPLE 2

In this example, when a user sends or receives e-mails or documents (such as attached documents) to or from someone or somewhere (i.e., a contact address related to the user (not limited to that of a person but including that of a company, place, etc.), all information about the e-mails or documents sent or received between the user and the contact address related to the user is obtained and displayed as a list.

First, the database is queried for a contact address related to the user (e.g., a contact address specified by From, To, CC, or the like in an e-mail sent from the user, a contact address registered as a contact address for the user by predetermined application software (optional), or a specific contact address), and that contact address is extracted (step S601). This processing begins upon a predetermined user operation.

Then, the database is queried for information about e-mails or documents sent or received between the user and the extracted contact address related to the user (e-mails or documents sent from the contact address to the user or sent from the user to the contact address) to obtain information about the sent or received e-mails or documents (step S602).

In this example, a collection of data of e-mails or documents stored by e-mail software or the above-mentioned predetermined application software is referred to as a database, and the electronic business card processing program 102 searches this collection of data. The obtained information about the e-mails or documents may include information such as the e-mails or documents themselves, as well as the full name of a person who created them, the name of the person's company or section, the person's background, the title of an event that the person attended, the person's contact address (the phone number, e-mail address, etc.).

When the information is obtained at step S602, the name of the contact address related to the user in the obtained information is added to a list (e.g., on the basis of predetermined categories, such as event attendee, e-mail sender or recipient, etc.) (S604). The name for the contact address included in this list is associated with the information obtained at step S602 in this embodiment as well.

Further, the information obtained by the search at step S602 is stored (step S605).

Subsequently, steps S602 to S605 are repeated until no more relevant e-mails or documents are found, at which point the processing transitions to step S606. If the information has been obtained, a view is displayed on the basis of predetermined categories (S607). The view includes: the list; detailed information about a selected one (by default, it may be the previously retrieved contact address) of the retrieved contact addresses (e.g., if the target is a person, the person's business card information, the name of the person's company, the person's position, the person's contact address (the phone number, e-mail address, etc.) and so forth); and information about e-mails or documents sent to or received from this contact address.

The view of these items including the list may be displayed in such a manner that a portion displayable in the display area is displayed and the remaining portion is displayed by scrolling. The information about the e-mails or documents displayed in the view is associated with the e-mails or documents themselves, to which a direct reference may be made.

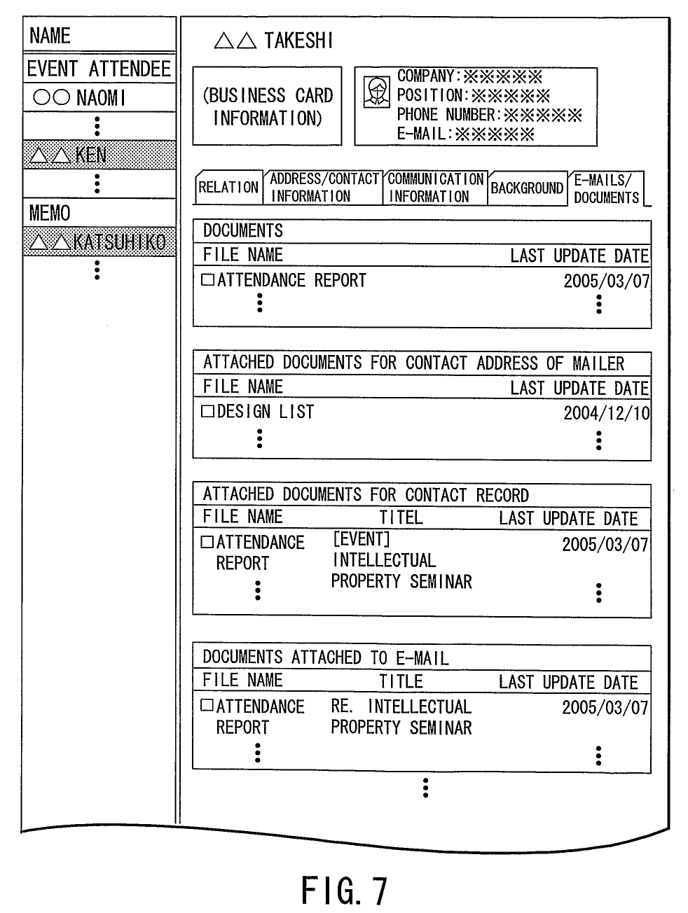

FIG. 7 shows an exemplary display of a search result.

As shown, a view or list of names of contact addresses is displayed as a search result (the left side of the figure). When a particular name in the list displayed in this manner is specified using indicating means implemented as an input device such as a mouse, for example by clicking, a view of information about e-mails or documents sent to or received from the specified particular contact address is displayed in a classified and highlighted manner in predetermined categories (shown in the right column in the figure). Therefore, the user can readily know the senders or recipients of e-mails or documents from the list. Furthermore, the user can readily know information about e-mails or documents sent to or received from a particular contact address in the list, as well as the sent or received e-mails or documents themselves.

The information processing flows described in the respective examples are only illustrative, and the present invention is not limited to these processing flows.

The present invention has been described in detail with respect to a preferred embodiment, and it will be now be apparent from the foregoing to those skilled in the art that changes and modifications may be made without departing from the invention in its broader aspect, and it is the intention, therefore, in the apparent claims to cover all such changes and modifications as fall within the true spirit of the invention.

1. An information retrieving and displaying method for extracting from information stored in a computer system, all information associated with a certain keyword and displaying it in a classified and highlighted manner for easy recognition by a user, the method comprising steps of:
storing a set of contact address records, each of which specifies a name of a person and personal information about the person;
receiving the keyword from the user;
retrieving ones of the contact address records that contain the keyword;
extracting the names from contact address records retrieved by the retrieving step; and
displaying a list of the names extracted by the extracting step.

2. The information retrieving and displaying method according to claim 1, wherein the method further comprises displaying in a pop-up manner, when one of the names displayed in the list is indicated by a predetermined indicating means, information indicating why the indicated one of the names was included in the list.

3. The information retrieving and displaying method according to claim 2, wherein the indication by the indicating means is indication by an input device.

4. The information retrieving and displaying method according to claim 1,
wherein the computer system is a network system, and
wherein storing the set of contact address records comprises storing the contact address records in a server and a terminal which constitute the network system.

5. An information retrieving and displaying method for extracting from information stored in a computer system, all information associated with a certain keyword and displaying it in a classified and highlighted manner for easy recognition by a user, the method comprising steps of:
storing a set of contact address records that includes a subset of contact address records, wherein each of the contact address records specifies personal information about a person;
retrieving information about electronic documents which the user has sent to or received from persons whose personal information is specified by contact address records in the subset of contact address records; and
displaying in a list the information about the electronic documents retrieved by the retrieving step.

6. The information retrieving and displaying method according to claim 5, wherein the subset of the contact address records includes contact address records registered by the user.

7. The information retrieving and displaying method according to claim 5,
wherein each of contact address records specifies personal information that includes an e-mail address of a person; and
wherein the subset of the contact address records includes ones of the contact address records that specify personal information that includes e-mail addresses specified in “From”, “To”, and “CC” fields of e-mails sent to the user and email addresses specified in “From”, “To”, and “CC” fields of e-mails received by the user.

8. The information retrieving and displaying method according to claim 5,
wherein retrieving information about electronic documents comprises retrieving information about electronic documents which the user has sent to or received from one contact person whose personal information is specified by the contact address records in the subset of contact address records; and
wherein the method further comprises displaying a document list that consists of entries, wherein each of the entries specifies one of the retrieved sets of information about one of the electronic documents that the user has sent to or received from the one contact person.

9. The information retrieving and displaying method according to claim 5, wherein the method further comprises:
displaying a contact address list that lists names specified in the personal information specified by the contact address records in the subset of contact address records; and
displaying a document list that lists the information about the electronic documents that the user has sent to or received from a person whose name is specified in the personal information specified by one of the contact address records in the subset of contact address records.

10. The information retrieving and displaying method according to claim 5,
wherein the computer system is a network system, and
wherein the method further comprises storing the set of contact address records in a server and a terminal which constitute the network system.

11. A computer-readable medium having a program stored thereon, the program causing a computer to execute an information retrieving and displaying method for extracting from information stored in a computer system, all information associated with a certain keyword and displaying it in a classified and highlighted manner for easy recognition by a user, the program comprising the steps of:
storing a set of contact address records each of which specifies a name of a person and personal information about the person;
receiving the keyword from the user;
retrieving ones of the contact address records that contain the keyword;
extracting the names from the contact address records retrieved by the retrieving step; and
displaying a list of the names.

12. The computer-readable medium according to claim 11, wherein the program further comprises the step of displaying in a pop-up manner, when one of the names displayed in the list is indicated by a certain indicating means, information indicating why the indicated one of the names was included in the list.

13. The computer-readable medium according to claim 12, wherein the indication by the indicating means is indication by a mouse.

14. The computer-readable medium according to claim 11,
wherein the computer system is a network system, and
wherein storing the set of contact address records comprises storing the contact address records in a server and a terminal which constitute the network system.

15. A computer-readable medium having a program stored thereon, the program causing a computer to execute an information retrieving and displaying method for extracting from information stored in a computer system, all information associated with a certain keyword and displaying it in a classified and highlighted manner for easy recognition by a user, the program comprising the steps of:
storing, in a database, a set of contact address records, wherein each of the contact address records specifies a name of a person and an e-mail address of the person;
storing, in the database, sets of information about electronic documents;
storing an e-mail that specifies a first e-mail address and a second e-mail address, wherein the first e-mail address is associated with a first person;
in response to displaying the e-mail, receiving, from the first person, input that indicates that the first person wants to view information about documents sent to the first person from a person associated with the second e-mail address and documents received by the first person from the person associated with the second e-mail address;
in response to the input, extracting the second e-mail address from the e-mail;
querying the database for a contact address record that specifies the e-mail address of the person associated with the second e-mail address;
using information in the contact address record that specifies the e-mail address of the person associated with the second e-mail address to retrieve, from the database, information about ones of the electronic documents that were sent to the first person by the person associated with the e-mail address and ones of the electronic documents that were send to the person associated with the e-mail address by the first person; and
displaying to the first person a list of the information about the electronic documents retrieved by the retrieving step.

16. The computer-readable medium according to claim 15, wherein the second email address is registered by the first person.

17. The computer-readable medium according to claim 15, wherein extracting the second e-mail address from the e-mail comprises extracting the second e-mail address from an e-mail address header field of the e-mail.

18. The computer-readable medium according to claim 15, wherein the program further comprises the step of displaying a list that includes the name of the person associated with the second e-mail address.

19. The computer-readable medium according to claim 18,
wherein each of the contact address records specifies business card information of a person; and
wherein the program further comprises the step of: after retrieving the information about the ones of the electronic documents displaying the business card information of the person associated with the second e-mail address.

20. The computer-readable medium according to claim 15,
wherein the computer system is a network system, and
wherein storing the set of contact address records comprises storing the set of contact address records in a server and a terminal which constitute the network system.
